(19) United States
(12) Patent Application Publication
(10) Pub. No.: US 2018/0290173 A1
(43) Pub. Date: Oct. 11, 2018

(54) METHOD FOR COATING A PREFERABLY PLATE-SHAPED WORKPIECE

(71) Applicant: HOMAG GmbH, Schopfloch (DE)

(72) Inventor: Achim HOMEIER, Pfalzgrafenweiler (DE)

(21) Appl. No.: 15/765,241

(22) PCT Filed: Sep. 29, 2016
(86) PCT No.: PCT/EP2016/073243

§ 371 Date: Mar. 30, 2018

(30) Foreign Application Priority Data
Oct. 2, 2015 (DE) 10 2015 219 102.8

(51) Int. Cl. B05D 7/06; B05D 7/00; B27D 5/00

(52) U.S. Cl. CPC B05D 7/06; B05D 7/52; B05C 1/0865; B27D 5/006; B27D 5/003

(57) ABSTRACT

The invention relates to a method which has applications in the furniture and component industry. In particular, planar workpieces are coated in order to adapt their exteriors to the wishes of individual customers. A curable substance is applied and a three-dimensional structure is thus produced, at least partially in the region of the narrow side surface layer.

### TECHNICAL FIELD

The present invention relates to a method to be used in the furniture and component industry sector. In particular, planar workpieces are coated in order to adapt their exterior to the individual wishes of customers. Said workpieces are preferably planar workpieces such as kitchen counters, shelves, furniture fronts, floor panels or the like, which at least partially consist of wood, wood materials or the like.

### PRIOR ART

In the prior art, there is a trend towards decorations having a three-dimensional embossing, for example, in order to haptically imitate a wood structure. For the embossing (ideally “synchronous” to wood structure), embossing rollers or embossing plates are used which create a structure depth of approximately 90 to 120 μm. In an extreme case, depths of 300 μm are achieved or sought. However, the embossing roller must be adapted or exchanged for each new structure. Accordingly, an individualized single piece product is not possible. Furthermore, said embossing technique is only used for planar surfaces and therefore the range of applications of this method is limited.

When cutting panels of plate-shaped workpieces having a wood structure, in order to create a veneer finish across a furniture front, the structure along the component surface must be taken into account. During production, this leads to many trimmings and due to, for example, reworking in the edge area by means of scrapers or the like, a continuous structure in the transition area of a main side to a narrow side of the workpiece often cannot be created.

### SUBJECT MATTER OF THE INVENTION

The object of the present invention is to provide a method for coating plate-shaped workpieces with which an individual, high-quality and continuous coating can be provided.

The present invention provides a method according to claim 1 for this. Further preferred embodiments are stated in the dependent claims.

The method according to the invention has the advantage that a seamless jointworkpiece coating having a continuous surface in combination with a structure is made possible. By avoiding cutoffs, a reduction of the material consumed is achieved. Since it is possible to first use the method according to the invention at a relatively late stage of the process, an individualized production can be pursued, and workpiece sorting procedures and part buffers of workpieces can be reduced.

Within the scope of the present invention, a three-dimensional structure is a structure having a structure depth of at least 90 μm.

The method according to the invention comprises the steps: pre-treating a narrow side of the plate-shaped workpiece to create a narrow side surface layer, in particular by means of an edge material strip or a paste-like compound, effecting a relative movement between a workpiece and an application device, said application device being configured to apply a curable substance for forming a three-dimensional structure, as well as applying the curable substance and hereby forming a three-dimensional structure at least in sections in the area of the narrow side surface layer.

By pre-treating the narrow side of the workpiece, in particular with workpieces which have pores or irregularities in this area, these pores or irregularities can be evened out. Applying the curable substance enables the formation of the three-dimensional structure such that, for example, inter alia an appealing outer appearance can be achieved.

According to one preferred embodiment, the curable substance is additionally applied to the main side of the workpiece (W). In this manner, a uniform design of the workpiece is provided.

Furthermore, the narrow side surface layer can be machined, in particular by means of a milling cutter and/or a scraper, before application of the three-dimensional structure in the edge area/corner area of the narrow side of the workpiece. Consequently, possible projections are removed and a transition from a narrow side to a main side is introduced. In particular, a radius is provided in the edge area R.

Within the scope of the invention, the machined edge area (R) can be provided with the curable substance and a three-dimensional structure is consequently formed. In this manner, the machined area, which is optionally formed as a radius, is covered with the curable substance

According to one further embodiment, the application device is guided starting from one main side of the workpiece to a narrow side of the workpiece, or vice-versa, with the application device performing a continuous application during the movement. A uniform transition from the main to the narrow side of the workpiece is ensured by this preferred procedure. Furthermore, reworked edge areas/corner areas which, as mentioned above, have been machined for example, can be covered and a visually appealing decoration can be provided in the edge or corner area.

Within the framework of the invention, the three-dimensional structure can replicate a wood surface. Consequently, it is possible to impart a freely selectable and optionally higher quality surface structure to a workpiece.

According to one embodiment, the application of the curable substance is performed plural times in order to raise a structure depth of the three-dimensional structure.

Within the framework of the invention, the narrow side surface layer can remain visible in sections after the application of the curable substance. In this case, the exposed sections of the narrow side surface layer would contribute to the visual appearance. Alternatively, during the application of the curable substance, it is possible to completely cover the narrow side surface layer therewith so that only the curable substance is visible.

It is further preferred that the three-dimensional structure comprises a structure depth of 90 to 300 μm, preferably 150 to 300 μm. In one specific example, a wood surface structure can be recreated in this manner. However, other three-dimensional structures can be replicate as well.

### BRIEF DESCRIPTION OF THE DRAWING

FIG. 1 is a schematic illustration to illustrate the method according to the invention.

### DETAILED DESCRIPTION OF THE PREFERRED EMBODIMENTS

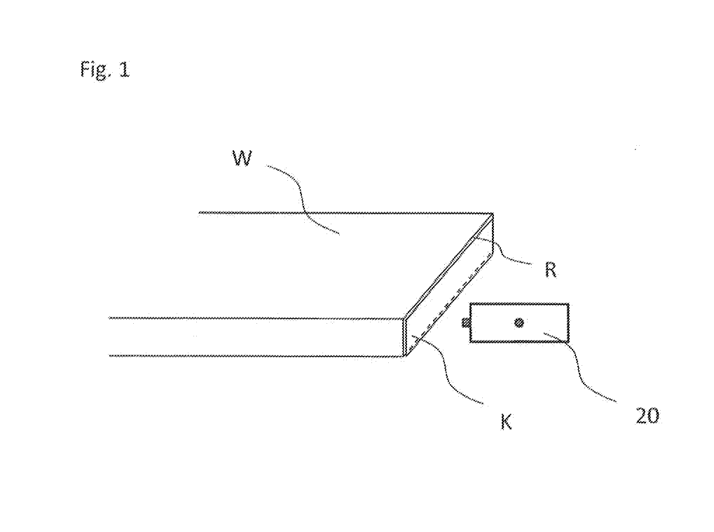

In the following, one preferred embodiment of the present invention will be discussed on the basis of the schematic illustration of FIG. 1. Further modifications of certain features mentioned in this context can each be combined with one another in order to form new embodiments.

Firstly, a workpiece W is provided which is, for example, a particleboard, an MDF-board or the like. After cutting such a workpiece W, it has an uneven surface or a surface provided with pores, in the area of the narrow side. Within the scope of the present embodiment, this surface is first provided with a blind edge K in order to obtain an even surface layer (“narrow side surface layer”). The blind edge K is a strip-shaped coating material having a visually neutral, for example, single-color appearance.

Alternatively to the blind edge, a paste-like compound can be applied, for example, to the narrow side of the workpiece in order to even out said irregularities. In a subsequent method step, the paste-like compound can be processed, for example, by means of a grinding apparatus.

After the narrow side surface layer has been provided, a machining can subsequently be performed in order to remove possible projections of the blind edge K or the paste-like compound on the workpieces. In this manner, a radius in the transition area R between the narrow side and the main side of the workpiece is furthermore introduced.

Moreover, in an optional method step, it is possible to subject the blind edge K or the paste-like compound to a pre-treatment in order to obtain the adhesive properties for the curable substance that is to be applied by an application device 20. For example, the narrow side surface layer can be blown off with pressurized air or provided with a bonding agent.

In a subsequent method step, the workpiece is moved in the area of an application device 20 which is configured to apply a three-dimensional structure to the workpiece W. So that the narrow side of the plate-shaped workpiece W, which is provided with the narrow side surface layer can be coated without a joint, the application device 20 is provided pivotably so as to be able to also coat the transition area from the narrow side to the main side of the workpiece, in addition to the commonly flat narrow side. As set out above, the transition area is thereby commonly formed as a radius which is, for example, created by a processing after applying the blind edge or the paste-like compound.

In the course of the application, the structure that is applied by the application unit 20 can be adapted to that which is optionally already present on the main side of the workpiece W. This relates to the visual appearance (decoration) as well as the structure per se which transitions in the area of the radius into the surface structure of the main side of the workpiece W.

Alternatively, it is possible to coat the narrow side as well as the main side in one operation by means of the application unit 20, and in this manner to also ensure a joint-less transition between the narrow side and main side of the workpiece.

Although a flat narrow side was described within the scope of the preferred embodiment, it is apparent that the application unit 20 is furthermore configured to coat curved narrow sides (drum profile). Narrow sides which have already been provided with a profile can also be treated by means of the application unit. These can be, for example, a wave profile, transverse or longitudinal grooves or the like.

According to one variant, the blind edge K or the paste-like compound can be provided with color particles such that these impart the surface which is to be subsequently coated with a “base color”, if the blind edge and the paste-like compound are to be coated only in sections by the application device 20.

Furthermore, in one final method step a varnish can be applied to the surfaces of the workpiece W in order to seal it and to additionally protect it against mechanical effect or the penetration of moisture.

1. Method for coating a plate-shaped workpiece which at least in sections consists of wood, wood materials, composite materials, or a combination thereof, comprising the steps:
Pre-treating a narrow side of the plate-shaped workpiece to create a narrow side surface layer, in particular by means of an edge material strip (K) or a paste-like compound,
Effecting a relative movement between a workpiece (W) and an application device (20), said application device (20) being configured to apply a curable substance for forming a three-dimensional structure,
Applying the curable substance and hereby forming a three-dimensional structure at least in sections in the area of the narrow side surface layer.

2. Method according to claim 1, in which the curable substance is additionally applied to the main side of the workpiece (W).

3. Method according to one of the preceding claims, in which the narrow side surface layer is machined, in particular by means of a milling cutter and/or a scraper, before application of the curable substance in the edge area (R) of the narrow side of the workpiece (W).

4. Method according to claim 1, in which the processed edge area (R) is provided with the curable substance and a three-dimensional structure is consequently formed.

5. Method according to claim 2, 3 or 4, in which the application device (20) is guided starting from one main side of the workpiece to a narrow side of the workpiece (W), or vice-versa, the application device (20) performing a continuous application during the movement.

6. Method according to one of the preceding claims, in which the three-dimensional structure replicates a wood surface.

7. Method according to one of the preceding claims, in which the application of the curable substance is performed plural times in order to raise a structure depth of the three-dimensional structure.

8. Method according to one of the preceding claims, in which the narrow side surface layer remains visible in sections after the application of the curable substance.

9. Method according to one of claims 1 to 7, in which during the application of the curable substance, the narrow side surface layer is completely covered therewith.

10. Method according one of claims 1 to 9, in which the three-dimensional structure comprises a structure depth of 90 to 300 μm, preferably 150 to 300 μm.
